(19) United States
(12) Patent Application Publication
(10) Pub. No.: US 2022/0410893 A1
(43) Pub. Date: Dec. 29, 2022

(54) VEHICLE CONTROL DEVICE AND VEHICLE CONTROL METHOD

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Shuntaro OKAZAKI, Sunto-gun (JP); Shogo TSUGE, Fuji-shi (JP); Kazuhisa MATSUDA, Sunto-gun (JP)

(21) Appl. No.: 17/808,543

(22) Filed: Jun. 24, 2022

(30) Foreign Application Priority Data
Jun. 25, 2021 (JP) 2021-105997

(51) Int. Cl. B60W 30/14; B60W 30/16; B60W 30/18; B60W 40/04; B60L 53/126; B60L 58/13

(52) U.S. Cl. CPC B60W 30/146; B60W 30/16; B60W 30/18163; B60W 40/04; B60L 53/126; B60L 58/13; B60W 2510/244; B60W 2554/406; B60W 2554/80; B60L 2240/12; B60L 2240/68

(57) ABSTRACT

The vehicle control device controls a vehicle configured to receive power by non-contact from a power transmission coil when passing over the power transmission coil. The vehicle control device includes a processor configured to set a target speed of the vehicle in a power supply area where the power transmission coil is installed. The processor is configured to lower the target speed when at least one predetermined condition is satisfied, compared to when the at least one predetermined condition is not satisfied. The at least one predetermined condition includes a first condition relating to a running environment around the vehicle.

### FIELD

The present disclosure relates to a vehicle control device and a vehicle control method.

### BACKGROUND

It has been known in the past to use a transmission method such as magnetic field resonance coupling to transmit power by non-contact between a power supply apparatus provided at a ground and a vehicle (for example, PTL 1). Normally, the power transmission coil of the power supply apparatus would be installed on a part of a road over which the vehicle will run. For this reason, there will be a shorter power supply time if the vehicle passes through the power supply area where the power transmission coil is installed at a high speed which in turn results in a lower amount of power supplied to the vehicle.

To address this, the control device of the electric vehicle disclosed in PTL 1 controls the speed of the vehicle so that the state of charge of the battery of the vehicle will reach a target value when the vehicle arrives at the exit of the power supply area. Therefore, if the amount of charge required of the battery is large, the vehicle will decelerate when passing through the power supply area.

### CITATION LIST

### Patent Literature

### [PTL 1] Japanese Unexamined Patent Publication No. 2019-068500

### SUMMARY

### Technical Problem

However, in PTL 1, there is no consideration on how changing the speed of the vehicle in the power supply area will affect surrounding traffic. For example, decelerating the vehicle in the power supply area could force a rear vehicle running behind the vehicle to brake.

Therefore, in consideration of the above problem, an object of the present disclosure is to increase the amount of power supplied to a vehicle while considering surrounding traffic when the vehicle passes through a power supply area.

### Solution to Problem

The summary of the present disclosure is as follows.

(1) A vehicle control device for controlling a vehicle configured to receive power by non-contact from a power transmission coil when passing over the power transmission coil, comprising: a processor configured to set a target speed of the vehicle in a power supply area where the power transmission coil is installed, wherein the processor is configured to lower the target speed when at least one predetermined condition is satisfied, compared to when the at least one predetermined condition is not satisfied, and the at least one predetermined condition includes a first condition relating to a running environment around the vehicle.

(2) The vehicle control device described in above (1), wherein the first condition includes a positional condition relating to a positional relationship between a rear vehicle running behind the vehicle and the vehicle.

(3) The vehicle control device described in above (2), wherein the positional condition is satisfied when a distance between the vehicle and the rear vehicle is equal to or greater than a predetermined distance.

(4) The vehicle control device described in above (2), wherein the positional condition is satisfied when a time to collision of the rear vehicle with respect to the vehicle when the target speed of the vehicle is lowered is equal to or greater than a predetermined time.

(5) The vehicle control device described in above (2), wherein the positional condition is satisfied when a time for the rear vehicle to reach a current position of the vehicle is equal to or greater than a predetermined time.

(6) The vehicle control device described in any one of above (2) to (5), wherein the rear vehicle is a following vehicle located behind the vehicle on the same lane as the vehicle.

(7) The vehicle control device described in any one of above (1) to (6), wherein the first condition includes a lane-changing condition relating to an ease of changing lanes from a lane of the power supply area to another lane.

(8) The vehicle control device described in above (7), wherein the lane-changing condition is satisfied when the number of lanes in the same direction of advance on a road where the power supply area has been established is equal to or greater than a predetermined number of two or more.

(9) The vehicle control device described in above (7), wherein the lane-changing condition is satisfied when the number of surrounding vehicles located in a predetermined range on a lane adjacent to the lane of the power supply area is equal to or less than a predetermined number.

(10) The vehicle control device described in any one of above (1) to (9), wherein the first condition includes a congestion condition relating to congestion in an area in front of the power supply area.

(11) The vehicle control device described in above (10), wherein the congestion condition is satisfied when there is no possibility of congestion in the area in front of the power supply area.

(12) The vehicle control device described in any one of above (1) to (11), wherein the vehicle comprises a battery, and the at least one predetermined condition includes a second condition relating to a state of the battery.

(13) The vehicle control device described in any one of above (1) to (12), wherein the at least one predetermined condition includes a third condition relating to operating schedule of the vehicle or a schedule of an occupant of the vehicle.

(14) The vehicle control device described in above (13), wherein the third condition is satisfied when the occupant has no schedule within a predetermined time from an estimated time of arrival of the vehicle at a destination.

(15) The vehicle control device described in any one of above (1) to (14), wherein the vehicle comprises an output device, and the processor is configured to make the output device output a deceleration instruction so that a speed of the vehicle in the power supply area approaches the target speed, if the at least one predetermined condition is satisfied.

(16) The vehicle control device described in any one of above (1) to (14), wherein the processor is configured to control running of the vehicle, and decelerate the vehicle so that the speed of the vehicle in the power supply area approaches the target speed, if the at least one predetermined condition is satisfied.

(17) A vehicle control method for controlling a vehicle configured to receive power by non-contact from a power transmission coil when passing over the power transmission coil, including: lowering a target speed of the vehicle in a power supply area where the power transmission coil is installed, when at least one predetermined condition is satisfied, compared to when the at least one predetermined condition is not satisfied, wherein the at least one predetermined condition includes a first condition relating to a running environment around the vehicle.

According to the present disclosure, it is possible to increase the amount of power supplied to a vehicle while considering surrounding traffic when the vehicle passes through a power supply area.

### BRIEF DESCRIPTION OF DRAWINGS

FIG. 1 is a view schematically showing a configuration of a non-contact power supply system.

FIG. 2 is a schematic view of a configuration of a controller and equipment connected to the controller.

FIG. 3 is a schematic view of a configuration of an ECU of a vehicle according to a first embodiment and equipment connected to the ECU.

FIG. 4 is a view showing one example of a power supply area in which power transmission coils of a power supply apparatus are installed.

FIG. 5 is a functional block diagram of a processor of the ECU in the first embodiment.

FIG. 6 is a flow chart showing a control routine carried out in the vehicle in the first embodiment.

FIG. 7 is a view showing one example of the positional relationship between the vehicle and a rear vehicle.

FIG. 8 is a functional block diagram of an ECU of a vehicle according to a second embodiment and equipment connected to the ECU.

FIG. 9 is a functional block diagram of a processor of the ECU in the second embodiment.

FIG. 10 is a flow chart showing a control routine carried out in the vehicle in the second embodiment.

FIG. 11 is a view schematically showing a vehicle according to a third embodiment.

FIG. 12 is a view schematically showing a configuration of a server.

FIG. 13 is a flow chart showing a control routine carried out in the server in the third embodiment.

FIG. 14 is a flow chart showing a control routine carried out in the vehicle in the third embodiment.

### DESCRIPTION OF EMBODIMENTS

Below, referring to the drawings, embodiments of the present disclosure will be explained in detail. Note that, in the following explanation, similar component elements will be assigned the same reference notations.

### First Embodiment

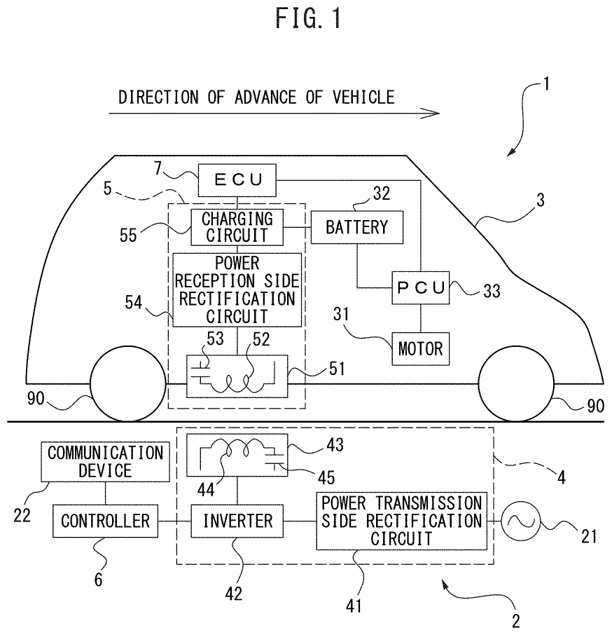

Below, referring to FIG. 1 to FIG. 7, a first embodiment of the present disclosure will be explained.

First, the configuration for transmitting power from a power supply apparatus provided at the ground to a vehicle will be explained. FIG. 1 is a view schematically showing a configuration of a non-contact power supply system 1. The non-contact power supply system 1 is provided with a power supply apparatus 2 and a vehicle 3 and supplies power by non-contact between the power supply apparatus 2 and the vehicle 3. In particular, in the present embodiment, the non-contact power supply system 1 transmits power by non-contact from the power supply apparatus 2 to the vehicle 3 by magnetic field resonance coupling (magnetic field resonance) when the vehicle 3 is running. That is, the non-contact power supply system 1 transmits power from the power supply apparatus 2 to the vehicle 3 using a magnetic field as a medium. Note that, non-contact power supply is also called non-contact power transfer, wireless power transfer, or wireless power supply.

The power supply apparatus 2 is configured to supply power to the vehicle 3 by non-contact. Specifically, as shown in FIG. 1, the power supply apparatus 2 is provided with a power transmission apparatus 4, a power supply 21, a controller 6, and a communication device 22. In the present embodiment, the power supply apparatus 2 is provided at a road (lane) on which the vehicle 3 runs and, for example, is buried in the ground (under the road surface). Note that, at least a part of the power supply apparatus 2 (for example, the power supply 21, the controller 6, and the communication device 22) may be placed on the road surface.

The power supply 21 is the power source of the power transmission apparatus 4 and supplies power to the power transmission apparatus 4. The power supply 21, for example, is a commercial alternating current power supply supplying single-phase alternating current power. Note that, the power supply 21 may be an alternating current power supply supplying three-phase alternating current power etc.

The power transmission apparatus 4 is configured to generate an alternating current magnetic field for transmitting power to the vehicle 3. In the present embodiment, the power transmission apparatus 4 is provided with a power transmission side rectification circuit 41, an inverter 42, and a power transmission side resonance circuit 43. In the power transmission apparatus 4, suitable alternating current power (high frequency power) is supplied through the power transmission side rectification circuit 41 and the inverter 42 to the power transmission side resonance circuit 43.

The power transmission side rectification circuit 41 is electrically connected to the power supply 21 and the inverter 42. The power transmission side rectification circuit 41 rectifies the alternating current power supplied from the power supply 21 to direct current power and supplies the direct current power to the inverter 42. The power transmission side rectification circuit 41 is, for example, an AC/DC converter.

The inverter 42 is electrically connected to the power transmission side rectification circuit 41 and power transmission side resonance circuit 43. The inverter 42 converts the direct current power supplied from the power transmission side rectification circuit 41 to alternating current power of a frequency higher than the alternating current power of the power supply 21 (high frequency power) and supplies the high frequency power to the power transmission side resonance circuit 43.

The power transmission side resonance circuit 43 has a resonator comprised of a power transmission coil 44 and a power transmission side capacitor 45. The various parameters of the power transmission coil 44 and the power transmission side capacitor 45 (outside diameter and inside diameter of the power transmission coil 44, turns of the power transmission coil 44, electrostatic capacity of the power transmission side capacitor 45, etc.) are determined so that the resonance frequency of the power transmission side resonance circuit 43 becomes a predetermined set value. The predetermined set value is, for example, 10 kHz to 100 GHz, preferably is the 85 kHz determined by the SAE TIR J2954 standard as the frequency band for non-contact power supply of vehicles.

The power transmission side resonance circuit 43 is arranged at the center of the lane over which the vehicle 3 runs so that the center of the power transmission coil 44 is positioned at the center of the lane. If high frequency power supplied from the inverter 42 is applied to the power transmission side resonance circuit 43, the power transmission side resonance circuit 43 generates an alternating current magnetic field for transmitting the power to the vehicle 3. Note that, the power supply 21 may be a fuel cell or solar cell or other such direct current power supply. In this case, the power transmission side rectification circuit 41 may be omitted.

The controller 6 is, for example, a general use computer and performs various control of the power supply apparatus 2. For example, the controller 6 is electrically connected to the inverter 42 of the power transmission apparatus 4 and controls the inverter 42 so as to control the power transmission by the power transmission apparatus 4. The controller 6 is one example of a control device of the power supply apparatus 2.

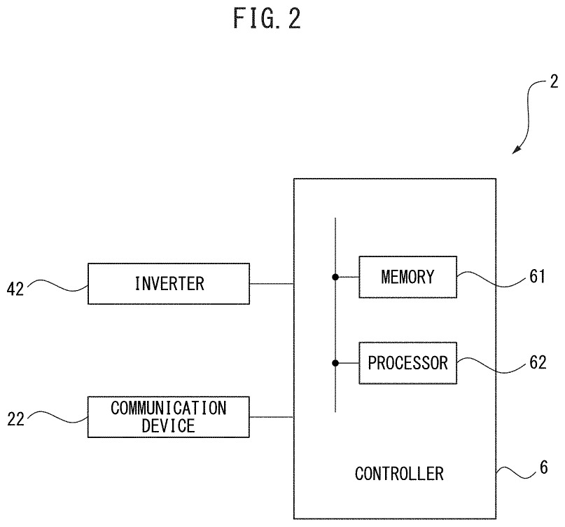

FIG. 2 is a schematic view of the configuration of the controller 6 and equipment connected to the controller 6. The controller 6 is provided with a memory 61 and a processor 62. The memory 61 and the processor 62 are connected with each other through signal wires. Note that, the controller 6 may be further provided with a communication interface etc. for connecting the controller 6 to a communication network such as the Internet.

The memory 61 has, for example, a volatile semiconductor memory (for example, a RAM) and a nonvolatile semiconductor memory (for example, a ROM). The memory 61 stores programs to be run at the processor 62, various data used when various processing is performed by the processor 62, etc.

The processor 62 has one or more CPUs (central processing units) and their peripheral circuits and performs various processing. Note that, the processor 62 may also have a logic unit or arithmetic unit or other such processing circuit.

The communication device 22 is equipment enabling communication between the power supply apparatus 2 and the outside of the power supply apparatus 2 (for example, a near field wireless communication module). The communication device 22 is electrically connected to the controller 6. The controller 6 communicates with the vehicle 3 using the communication device 22.

On the other hand, the vehicle 3 is configured to receive power by non-contact from the power transmission coil 44 when passing over the power transmission coil 44 of the power supply apparatus 2. Specifically, as shown in FIG. 1, the vehicle 3 is provided with a power reception apparatus 5, a motor 31, a battery 32, a power control unit (PCU) 33, and an electronic control unit (ECU) 7. In the present embodiment, the vehicle 3 is an electric vehicle (BEV) not mounting an internal combustion engine, and the motor 31 outputs drive power for running use.

The motor 31 is, for example, an alternating current synchronous motor and functions as a motor and a generator. When the motor 31 functions as a motor, the power stored in the battery 32 is used as the source of power for driving it. The output of the motor 31 is transmitted through a decelerator and axle to the wheels 90. On the other hand, at the time of deceleration of the vehicle 3, the motor 31 is driven by rotation of the wheels 90 and the motor 31 functions as a generator to produce regenerated power.

The battery 32 is a rechargeable secondary battery and is, for example, comprised of a lithium ion battery, nickel-hydrogen battery, etc. The battery 32 stores the power required for the vehicle 3 to run (for example, drive power of motor 31). If the regenerated power produced by the motor 31 is supplied to the battery 32, the battery 32 is charged and the state of charge of the battery 32 is restored. Further, the battery 32 can be charged by an outside power supply other than the power supply apparatus 2 through a charging port provided at the vehicle 3.

The PCU 33 is electrically connected to the battery 32 and motor 31. The PCU 33 has an inverter, booster converter, and DC/DC converter. The inverter converts the direct current power supplied from the battery 32 to alternating current power and supplies the alternating current power to the motor 31. On the other hand, the inverter converts the alternating current power generated by the motor 31 (regenerated power) to direct current power and supplies the direct current power to the battery 32. When the power stored in the battery 32 is supplied to the motor 31, the booster converter boosts the voltage of the battery 32 in accordance with need. When the power stored in the battery 32 is supplied to the headlights and other electronic equipment, the DC/DC converter lowers the voltage of the battery 32.

The power reception apparatus 5 is configured to receive power by non-contact from the power transmission apparatus 4. In the present embodiment, the power reception apparatus 5 is provided with a power reception side resonance circuit 51, power reception side rectification circuit 54, and charging circuit 55. The power reception apparatus 5 receives power from the power transmission apparatus 4 and supplies the received power to the battery 32.

The power reception side resonance circuit 51 is arranged at the bottom part of the vehicle 3 so that the distance from the road surface becomes smaller. In the present embodiment, the power reception side resonance circuit 51 is arranged at the center of the vehicle 3 in the vehicle width direction and is arranged between the front wheels 90 and the rear wheels 90 in the front-back direction of the vehicle 3.

The power reception side resonance circuit 51 has a configuration similar to the power transmission side resonance circuit 43 and has a resonator comprised of a power reception coil 52 and a power reception side capacitor 53. The various parameters of the power reception coil 52 and the power reception side capacitor 53 (outside diameter and inside diameter of the power reception coil 52, turns of the power reception coil 52, electrostatic capacity of the power reception side capacitor 53, etc.) are determined so that the resonance frequency of the power reception side resonance circuit 51 matches the resonance frequency of the power transmission side resonance circuit 43. Note that, if the amount of deviation of the resonance frequency of the power reception side resonance circuit 51 and the resonance frequency of the power transmission side resonance circuit 43 is small, for example, the resonance frequency of the power reception side resonance circuit 51 is within a range of ±20% of the resonance frequency of the power transmission side resonance circuit 43, the resonance frequency of the power reception side resonance circuit 51 does not necessarily have to match the resonance frequency of the power transmission side resonance circuit 43.

As shown in FIG. 1, when the power reception side resonance circuit 51 faces the power transmission side resonance circuit 43, if an alternating current magnetic field is generated at the power transmission side resonance circuit 43, the vibration of the alternating current magnetic field is transferred to the power reception side resonance circuit 51 which resonates by the same resonance frequency of the power transmission side resonance circuit 43. As a result, due to electromagnetic induction, an induction current flows to the power reception side resonance circuit 51, and due to the induction current, power is generated at the power reception side resonance circuit 51. That is, the power transmission side resonance circuit 43 transmits power to the power reception side resonance circuit 51 through a magnetic field, and the power reception side resonance circuit 51 receives power from the power transmission side resonance circuit 43 through a magnetic field.

The power reception side rectification circuit 54 is electrically connected to the power reception side resonance circuit 51 and the charging circuit 55. The power reception side rectification circuit 54 rectifies the alternating current power supplied from the power reception side resonance circuit 51 to convert it to direct current power and supplies the direct current power to the charging circuit 55. The power reception side rectification circuit 54 is, for example, an AC/DC converter.

The charging circuit 55 is electrically connected to the power reception side rectification circuit 54 and the battery 32. The charging circuit 55 converts the direct current power supplied from the power reception side rectification circuit 54 to the voltage level of the battery 32 and supplies it to the battery 32. If the power transmitted from the power transmission apparatus 4 is supplied by the power reception apparatus 5 to the battery 32, the battery 32 is charged and the SOC of the battery 32 is restored. The charging circuit 55 is, for example, a DC/DC converter.

The ECU 7 performs various types of control of the vehicle 3. For example, the ECU 7 is electrically connected to the charging circuit 55 of the power reception apparatus 5 and controls the charging circuit 55 to control charging of the battery 32 by the power transmitted from the power transmission apparatus 4. Further, the ECU 7 is electrically connected to the PCU 33 and controls the PCU 33 to control the transmission of power between the battery 32 and vehicle-mounted equipment (for example, the motor 31). Note that, the ECU 7 may supply the power received from the power transmission apparatus 4 through the power reception apparatus 5 to an electrical load (for example, the motor 31) instead of the battery 32. The ECU 7 is one example of a vehicle control device controlling the vehicle 3.

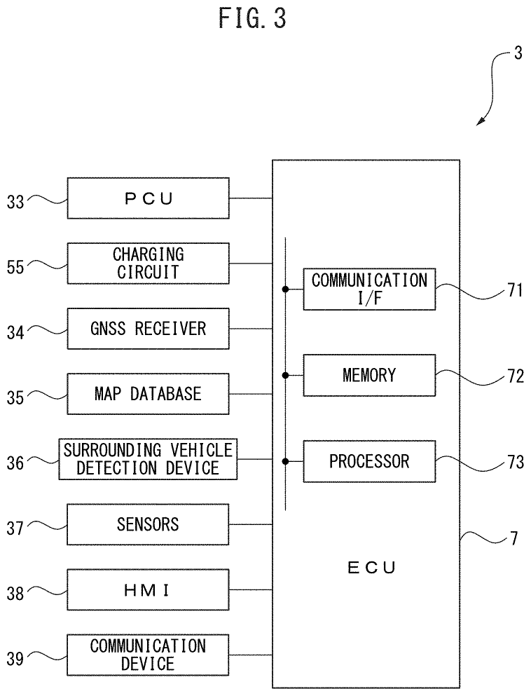

FIG. 3 is a schematic view of configuration of the ECU 7 of the vehicle 3 according to the first embodiment and equipment connected to the ECU 7. The ECU 7 has a communication interface 71, a memory 72, and a processor 73. The communication interface 71, the memory 72, and the processor 73 are connected together through signal wires.

The communication interface 71 has an interface circuit for connecting the ECU 7 to an internal vehicle network based on the CAN (Controller Area Network) or other standard.

The memory 72, for example, has a volatile semiconductor memory (for example, RAM) and nonvolatile semiconductor memory (for example, ROM). The memory 72 stores programs to be run at the processor 73, various data used when various processing is performed by the processor 73, etc.

The processor 73 has one or more CPUs (central processing units) and their peripheral circuits and performs various processing. Note that, the processor 73 may also have a logic unit or arithmetic unit or other such processing circuit.

Further, as shown in FIG. 3, the vehicle 3 is further provided with a GNSS receiver 34, a map database 35, a surrounding vehicle detection device 36, sensors 37, a HMI (Human Machine Interface) 38 and a communication device 39. The GNSS receiver 34, the map database 35, the surrounding vehicle detection device 36, the sensors 37, the HMI 38 and the communication device 39 are electrically connected to the ECU 7.

The GNSS receiver 34 detects the current position of the vehicle 3 (for example, a latitude and longitude of the vehicle 3) based on position measurement information obtained from a plurality of (for example, three or more) positioning satellites. Specifically, the GNSS receiver 34 captures a plurality of positioning satellites and receives signals emitted from the positioning satellites. Further, the GNSS receiver 34 calculates the distances to the positioning satellites based on the difference between the times of emission and times of reception of the signals and detects the current position of the vehicle 3 based on the distances to the positioning satellites and the positions of the positioning satellites (orbital information). The output of the GNSS receiver 34, that is, the current position of the vehicle 3 detected by the GNSS receiver 34, is sent to the ECU 7.

Note that, “GNSS” (Global Navigation Satellite System) is a general name of the GPS of the U.S., GLONASS of Russia, Galileo of Europe, QZSS of Japan, BeiDou of China, IRNSS of India, and other satellite positioning systems. Therefore, the GNSS receiver 34 includes a GPS receiver.

The map database 35 stores map information. The map information includes position information of the power supply area described later, etc. The ECU 7 acquires map information from the map database 35. Note that, the map database may be provided outside of the vehicle 3 (for example, the server etc.), and the ECU 7 may acquire map information from outside the vehicle 3.

The surrounding vehicle detection device 36 detects a surrounding vehicle in the surroundings of the vehicle 3 (host vehicle). Specifically, the surrounding vehicle detection device 36 detects the presence of a surrounding vehicle in the surroundings of the vehicle 3, the distance from the vehicle 3 to the surrounding vehicle, and the relative speed between the vehicle 3 and the surrounding vehicle. For example, the surrounding vehicle detection device 36 is constituted by a stereo camera, a laser imaging detection and ranging device (LIDAR), a millimeter wave radar or ultrasonic sensor (sonar), or any combination thereof. The output of the surrounding vehicle detection device 36 is transmitted to the ECU 7.

The sensors 37 detect the state of the vehicle 3. In the present embodiment, the sensors 37 include a vehicle speed sensor for detecting the speed of the vehicle 3, a battery temperature sensor for detecting the temperature of the battery 32, and a battery current sensor for detecting the input/output current with respect to the battery 32.

The HMI 38 performs input/output of information between the vehicle 3 and an occupant of the vehicle 3 (for example, the driver). The HMI 38 includes, for example, a display for displaying information, a speaker for emitting sound, an operation button, an operation switch, or a touchscreen with which the occupant enter inputs, a microphone for receiving occupant speech, etc. The output of the ECU 7 is communicated to the occupant via the HMI 38, and input from the occupant is transmitted to the ECU 7 via the HMI 38. The HMI 38 is one example of an input device, an output device, or an input/output device.

The communication device 39 is equipment enabling communication between the vehicle 3 and the outside of the vehicle 3 (for example, near field wireless communication module, a data communication module (DCM) for connecting the vehicle 3 to a communication network such as the Internet, etc.) The ECU 7 communicates with the power supply apparatus 2 using the communication device 39.

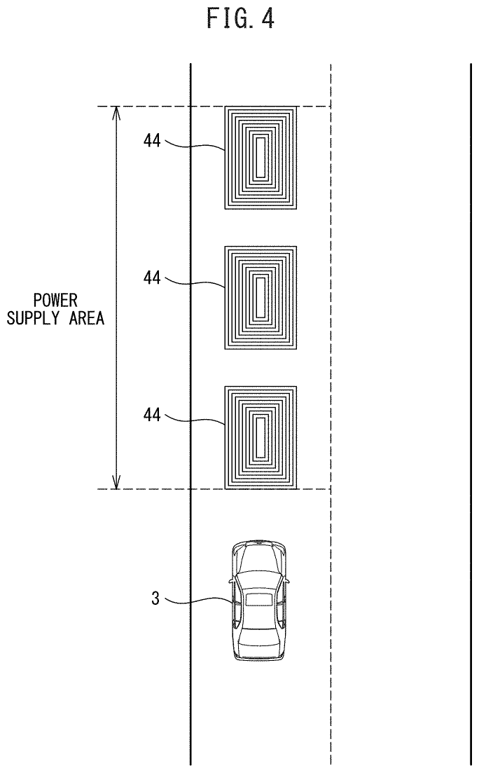

FIG. 4 is a view showing one example of a power supply area where the power transmission coils 44 of the power supply apparatus 2 are installed. In the example in FIG. 4, three power transmission coils 44 are installed on the same lane on a road and spaced apart along the direction of advance of the vehicle 3. The range on the lane over which the power transmission coils 44 are installed corresponds to the power supply area. Note that, the number of power transmission coils 44 installed in the power supply area may be another number (for example, one).

For example, ECU 7 emits a power supply request signal requesting power supply to the vehicle 3 from the power supply apparatus 2 using the communication device 39 when the vehicle 3 approaches a power supply area in which the power transmission coil 44 is installed. If receiving a power supply request signal from the vehicle 3, the controller 6 of the power supply apparatus 2 generates an alternating magnetic field for power transmission use by the power transmission apparatus 4. That is, if receiving a power supply request signal from the vehicle 3, the controller 6 starts to supply power by non-contact to the vehicle 3 from the power supply apparatus 2.

However, there will be a shorter power supply time if the vehicle 3 passes through the power supply area at high speed, which in turn results in a lower amount of power supplied to the vehicle 3. For this reason, it is desirable to reduce the speed of the vehicle 3 to the extent possible in order to maximize the amount of power supplied to the vehicle 3. On the other hand, changing the speed of the vehicle 3 in the power supply area could adversely affect the surrounding traffic. For example, decelerating the vehicle 3 in the power supply area could force a rear vehicle running behind the vehicle 3 to brake. Therefore, in the present embodiment, it is judged whether deceleration of the vehicle 3 in the power supply area is allowable in consideration of the surrounding traffic.

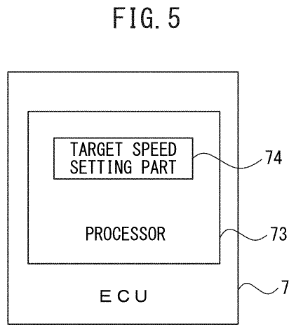

FIG. 5 is a functional block diagram of the processor 73 of the ECU 7 in the first embodiment. In the present embodiment, the processor 73 has a target speed setting part 74. The target speed setting part 74 is a functional module realized by a computer program stored in the memory 72 of the ECU 7 being run by the processor 73 of the ECU 7. Note that, the target speed setting part 74 may be realized by a dedicated processing circuit provided at the processor 73.

The target speed setting part 74 sets the target speed of the vehicle 3 in the power supply area and makes the HMI 38 output a deceleration instruction so that the speed of the vehicle 3 in the power supply area approaches the target speed. In particular, in the present embodiment, when predetermined conditions including a first condition relating to the running environment around the vehicle 3 is satisfied, the target speed setting part 74 lowers the target speed of the vehicle 3 in the power supply area, compared to when the predetermined conditions are not satisfied. That is, the target speed setting part 74 lowers the target speed of the vehicle 3 in the power supply area when the predetermined conditions are satisfied and does not lower the target speed of the vehicle 3 in the power supply area when the predetermined conditions are not satisfied. This makes it possible to increase the amount of power supplied to the vehicle 3 while considering surrounding traffic when the vehicle 3 is passing through the power supply area.

Further, in the present embodiment, the predetermined conditions include a second condition relating to the state of the battery 32 of the vehicle 3. This makes it possible to judge whether deceleration of the vehicle 3 is allowable in consideration of the state of the battery 32 and avoid unnecessary deceleration in the power supply area.

Further, in the present embodiment, the predetermined conditions include a third condition relating to the operating schedule of the vehicle 3 or a schedule of the occupant of the vehicle 3. This makes it possible to avoid problems in the operating schedule of the vehicle 3 or the schedule of the occupant of the vehicle 3 arising due to deceleration of the vehicle 3 in the power supply area.

As mentioned above, in the present embodiment, the predetermined conditions include the first condition, the second condition, and the third condition. In this case, the predetermined conditions are satisfied if the first condition, the second condition, and the third condition are satisfied. If at least one of the first condition, the second condition, and the third condition is not satisfied, the predetermined conditions are not satisfied.

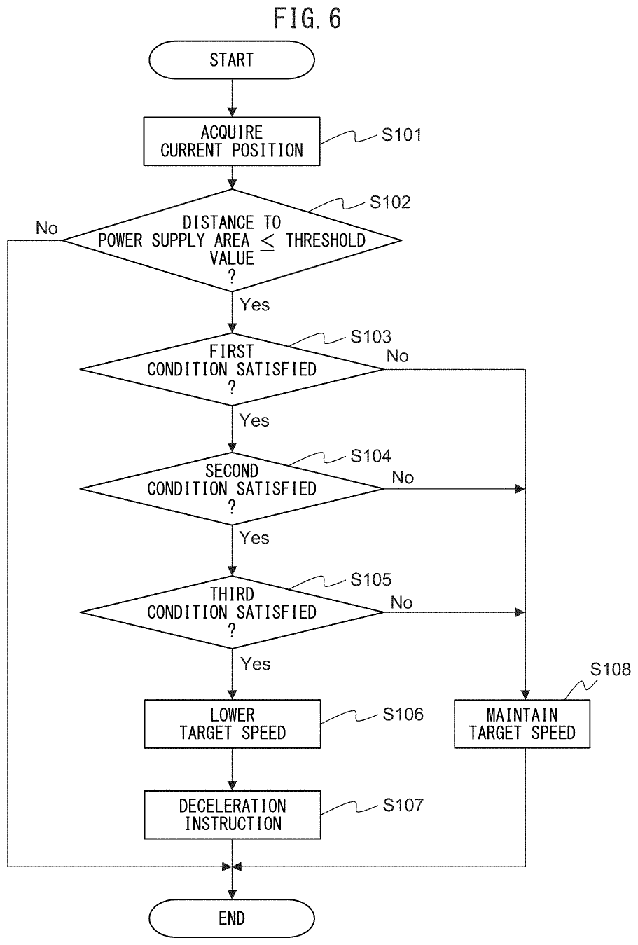

Below, referring to the flow chart of FIG. 6, the flow of the above-mentioned control will be explained. FIG. 6 is a flow chart showing a control routine carried out in the vehicle 3 in the first embodiment. The present control routine is repeatedly performed by the processor 73 of the ECU 7.

First, at step S101, the target speed setting part 74 acquires the current position of the vehicle 3 based on the output of the GNSS receiver 34.

Next, at step S102, the target speed setting part 74 judges whether the distance from the current position of the vehicle 3 to the power supply area is equal to or less than a predetermined threshold value. If it is judged that the distance to the power supply area is longer than the threshold value, the present control routine ends. On the other hand, if it is judged that the distance to the power supply area is equal to or less than the threshold value, the present control routine proceeds to step S103.

At step S103, the target speed setting part 74 acquires information relating to the running environment around the vehicle 3 and judges whether the first condition relating to the running environment around the vehicle 3 is satisfied. A surrounding vehicle in the periphery of the vehicle 3, in particular, a rear vehicle running behind the vehicle 3, is likely to be affected by deceleration of the vehicle 3. For this reason, for example, the first condition includes a positional condition relating to the positional relationship between a rear vehicle running behind the vehicle 3 and the vehicle 3. In this case, the first condition is not satisfied if the positional condition is not satisfied.

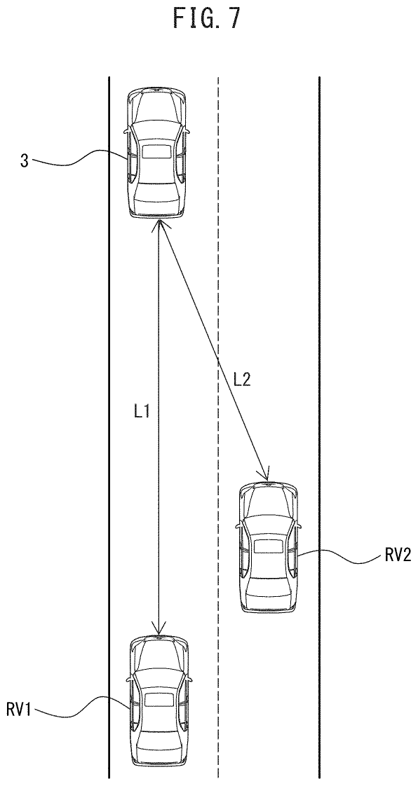

FIG. 7 is a view showing one example of the positional relationship between the vehicle 3 and rear vehicles. In the example in FIG. 7, there are two rear vehicles RV1 and RV2 behind the vehicle 3. The rear vehicles include not only a following vehicle located behind the vehicle 3 on the same lane as the vehicle 3 (rear vehicle RV1 in FIG. 7), but also a rear parallel running vehicle located behind the vehicle 3 in the lane different from the vehicle 3 (rear vehicle RV2 in FIG. 7).

If the vehicle 3 decelerates when there is a short distance between the vehicle 3 and a following vehicle, the following vehicle could be forced to brake. Further, if the vehicle 3 decelerates when there is a short distance between the vehicle 3 and a rear parallel running vehicle, the rear parallel running vehicle could be forced to brake if changing lanes to the lane of the vehicle 3. For this reason, for example, the positional condition is that the distance between the vehicle 3 and a rear vehicle be equal to or greater than a predetermined distance. In this case, the positional condition is satisfied when the distance between the vehicle 3 and the rear vehicle is equal to or greater than the predetermined distance and is not satisfied when the distance is less than the predetermined distance.

For example, the target speed setting part 74 acquires the distance between the vehicle 3 and a rear vehicle based on the output of the surrounding vehicle detection device 36 or vehicle information (for example, the current position of the rear vehicle) transmitted from the rear vehicle to the vehicle 3 by vehicle-to-vehicle communication. Note that, if a rear vehicle is not detected by the surrounding vehicle detection device 36 or a rear vehicle capable of communicating with the vehicle 3 by vehicle-to-vehicle communication is not present, the distance between the vehicle 3 and the rear vehicle will be treated as a predetermined value greater than the predetermined distance (for example, an infinite value), and the positional condition will be satisfied.

In the example in FIG. 7, the distance L2 between the rear vehicle RV2 in an adjacent lane and the vehicle 3 is shorter than the distance L1 between the rear vehicle RV1 in the same lane and the vehicle 3. For this reason, if the distance L2 is equal to or greater than the predetermined distance, the positional condition is satisfied. In the example in FIG. 7, the rear end part of the vehicle 3 is used as a reference position for the vehicle 3 (host vehicle), and the front end parts of the rear vehicles are used as reference positions for the rear vehicles RV1 and RV2. However, other positions (for example, the vehicle center) may be used as reference positions for the vehicle 3 and the rear vehicles RV1 and RV2. Further, the distance L2 between the vehicle 3 and the rear parallel running vehicle RV2 may be defined as a distance along the direction of advance of the vehicle 3.

Note that, the positional condition may be that the time to collision (TTC) of the rear vehicle with respect to the vehicle 3 when the target speed of the vehicle 3 is lowered is equal to or greater than a predetermined time. In this case, the positional condition is satisfied when the time to collision is equal to or greater than the predetermined time and is not satisfied when the time to collision is less than the predetermined time. The time to collision of the rear vehicle with respect to the vehicle 3 when the target speed of the vehicle 3 is lowered is calculated by dividing the distance between the vehicle 3 and the rear vehicle by the relative speed between the vehicle 3 after deceleration and the rear vehicle (speed of rear vehicle−target speed of vehicle 3 after deceleration).

Further, the positional condition may be that the time for a rear vehicle to reach the current position of the vehicle 3 (“time headway” (THW)), that is, the value obtained by dividing the distance between the vehicle 3 and the rear vehicle by the speed of the rear vehicle, be equal to or greater than the predetermined time. In this case, the positional condition is satisfied when the time for the rear vehicle to reach the current position of the vehicle 3 is equal to or greater than the predetermined time and is not satisfied when the time is less than the predetermined time.

In these cases, the target speed setting part 74 acquires the speed of a rear vehicle based on the output of the surrounding vehicle detection device 36 or vehicle information (for example, the speed of the rear vehicle) transmitted from the rear vehicle to the vehicle 3 by vehicle-to-vehicle communication. Note that, if a rear vehicle is not detected by the surrounding vehicle detection device 36 or a rear vehicle capable of communicating with the vehicle 3 by vehicle-to-vehicle communication is not present, the time to collision or the time for the rear vehicle to reach the current position of the vehicle 3 will be treated as a predetermined value greater than the predetermined time (for example, an infinite value), and the positional condition will be satisfied.

Further, a vehicle running behind the vehicle 3 in the same lane as the vehicle 3 is likely to be most affected by the behavior of the vehicle 3. For this reason, the rear vehicle to which the judgment of positional condition applies may be only the following vehicle. In this case, satisfaction of the positional condition is judged based on the positional relationship between the vehicle 3 and the following vehicle.

In this regard, if it is easy to change lanes from the power supply area lane to another lane, the rear vehicle can maintain a running speed by changing lanes, even when the vehicle 3 is decelerating. For this reason, the first condition may include a lane-changing condition relating to the ease of changing lanes from the power supply area lane to another lane. In this case, the first condition is not satisfied when the lane-changing condition is not satisfied.

For example, the lane-changing condition is that the number of lanes in the same direction of advance on a road where a power supply area has been established is equal to or greater than a predetermined number. In this case, the lane-changing condition is satisfied when the number of lanes is equal to or greater than the predetermined number and is not satisfied when the number of lanes is less than the predetermined number. The predetermined number is a number equal to or greater than two, for example, two or three.

Further, when there is a large amount of traffic in an adjacent lane, it is difficult to change lanes to the adjacent lane. For this reason, the lane-changing condition may be that the number of surrounding vehicles located in a predetermined range on a lane adjacent to the lane of the power supply area be equal to or less than a predetermined number. In this case, the lane-changing condition is satisfied when the number of surrounding vehicles located in the predetermined range on the adjacent lane is equal to or less than the predetermined number and is not satisfied when the number of surrounding vehicles is greater than the predetermined number. The predetermined range is, for example, a range covering a predetermined distance to the front and the back of the vehicle 3, a range covering a predetermined distance before the power supply area, etc. Note that, the predetermined number may be zero.

Further, there may conceivably be congestion in an area in front of the power supply area. Deceleration of the vehicle 3 when the area in front of the power supply area is congested could exacerbate the congestion. On the other hand, from the perspective of the occupant of the vehicle 3, there would be concern that the time of arrival at the destination which has been delayed by the congestion would become even later due to the vehicle 3 decelerating. For this reason, the first condition may include a congestion condition relating to congestion in an area in front of the power supply area. In this case, the first condition is not satisfied when the congestion condition is not satisfied.

For example, the congestion condition is that there is no possibility of congestion in the area in front of the power supply area. In this case, the congestion condition is satisfied when there is no possibility of congestion in the area in front of the power supply area and is not satisfied when there is a possibility of congestion occurring in the area in front of the power supply area. For example, the target speed setting part 74 judges whether there is a possibility of congestion occurring in the area in front of the power supply area based on road traffic information such as VICS® information or vehicle information (for example, the current location of surrounding vehicles, the speed of surrounding vehicles, etc.) transmitted from surrounding vehicles to the vehicle 3 by vehicle-to-vehicle communication. Note that, it is judged that there is a possibility of congestion occurring in the area in front of the power supply area when information indicating that there is already congestion in the area in front of the power supply area has been acquired.

Note that, the first condition may include at least one of the positional condition, the lane-changing condition, and the congestion condition. For example, when the first condition includes the positional condition, the lane-changing condition, and the congestion condition, the first condition is satisfied when all these conditions are satisfied and is not satisfied when at least one of these conditions is not satisfied.

If at step S103 it is judged that the first condition is satisfied, the present control routine proceeds to step S104. At step S104, the target speed setting part 74 acquires information relating to the state of the battery 32 of the vehicle 3 and judges whether the second condition relating to the state of the battery 32 is satisfied.

When the battery 32 has a high SOC, there is little need to increase the amount of power supplied to the vehicle 3. For this reason, the second condition includes, for example, the condition that the SOC of the battery 32 be equal to or less than a predetermined value. In this case, the second condition is not satisfied when the battery 32 has an SOC that is higher than the predetermined value. For example, the target speed setting part 74 calculates the SOC of the battery 32 by cumulatively adding the input/output current with respect to the battery 32 detected by a sensor 37 (specifically the battery current sensor).

Further, when the battery 32 has a high temperature, an increase in the amount of power supplied to the vehicle 3 could promote a rise in temperature in the battery 32. For this reason, the second condition may include the condition that the temperature of the battery 32 be equal to or less than a predetermined temperature. In this case, the second condition is not satisfied when the temperature of the battery 32 is higher than the predetermined temperature. For example, the target speed setting part 74 acquires the temperature of the battery 32 based on the output of a sensor 37 (specifically the battery temperature sensor).

If at step S104 it is judged that the second condition is satisfied, the present control routine proceeds to step S105. At step S105, the target speed setting part 74 acquires information relating to the operating schedule of the vehicle 3 or the schedule of the occupant of the vehicle 3 and judges whether a third condition relating to the operating schedule of the vehicle 3 or the schedule of the occupant of the vehicle 3 is satisfied.

For example, if the vehicle 3 is a vehicle providing a passenger transport service (bus, taxi, etc.) and the operating schedule of the vehicle 3 is determined in advance, it is necessary to avoid delays from the operating schedule to the extent possible. For this reason, the third condition is that, for example, there is no delay in the operating schedule of the vehicle 3. In this case, the third condition is satisfied when there is no delay in the operating schedule of the vehicle 3 and is not satisfied when there is a delay in the operating schedule of the vehicle 3. The operating schedule of the vehicle 3 is stored in, for example, the memory 72 of the ECU 7 or another memory device of the vehicle 3. The target speed setting part 74 judges whether there is a delay in the operating schedule of the vehicle 3 based on the current position of the vehicle 3 and operating schedule of the vehicle 3.

Further, if the occupant of the vehicle 3 has a schedule after getting off the vehicle, it is necessary to drive the vehicle 3 so as not to interfere with the schedule of the occupant. For this reason, the third condition may be that the occupant of the vehicle 3 has no schedule within a predetermined time from the scheduled time of arrival of the vehicle 3 at the destination. In this case, the third condition is satisfied when the occupant of the vehicle 3 has no schedule within the predetermined time from the estimated time of arrival and is not satisfied when the occupant of the vehicle 3 has a schedule within the predetermined time from the scheduled time of arrival.

The estimated time of arrival of the vehicle 3 at the destination is calculated using a known method based on the distance to the destination etc. On the other hand, the schedule of the occupant of the vehicle 3 is, for example, input into the HMI 38 by the occupant or transmitted from a portable terminal (a smartphone, a tablet terminal, a personal computer, etc.) of the occupant to the vehicle 3. The target speed setting part 74 judges whether the occupant of the vehicle 3 has a schedule within the predetermined time from the estimated time of arrival based on the estimated time of arrival of the vehicle 3 at the destination and the schedule of the occupant of the vehicle 3.

If at step S105 it is judged that the third condition is satisfied, the present control routine proceeds to step S106. At step S106, the target speed setting part 74 lowers the target speed of the vehicle 3 in the power supply area, that is, the target speed of the vehicle 3 when the vehicle 3 is passing through the power supply area. For example, the target speed setting part 74 sets the target speed of the vehicle 3 to a value lower than the current speed of the vehicle 3 by a predetermined value (for example, 5 km/h to 50 km/h).

Next, at step S107, the target speed setting part 74 makes the HMI 38 output a deceleration instruction so that the speed of the vehicle 3 in the power supply area approaches the target speed. The deceleration instruction includes text information, speech information, image information, etc. for prompting the driver of the vehicle 3 to decelerate. That is, the target speed setting part 74 visually or audibly notifies the driver of the vehicle 3 of the deceleration instruction via the HMI 38. Note that, the target speed setting part 74 may notify the driver of the vehicle 3 the target speed of the vehicle 3 in the power supply area or the difference between the target speed of the vehicle 3 in the power supply area and the current speed of the vehicle 3 as the deceleration instruction. After step S107, the present control routine ends.

On the other hand, if it is judged at step S103 that the first condition is not satisfied, it is judged at step S104 that the second condition is not satisfied, or it is judged at step S105 that the third condition is not satisfied, the present control routine proceeds to step S108. At step S108, the target speed setting part 74 maintains the target speed of the vehicle 3 in the power supply area at the current speed of the vehicle 3. That is, the target speed setting part 74 does not change the target speed of the vehicle 3. After step S108, the present control routine ends.

### Second Embodiment

The configuration and control of the vehicle according to a second embodiment are basically similar to the configuration and control of the vehicle according to the first embodiment except for the points explained below. For this reason, below, the second embodiment of the present disclosure will be explained focusing on parts different from the first embodiment.

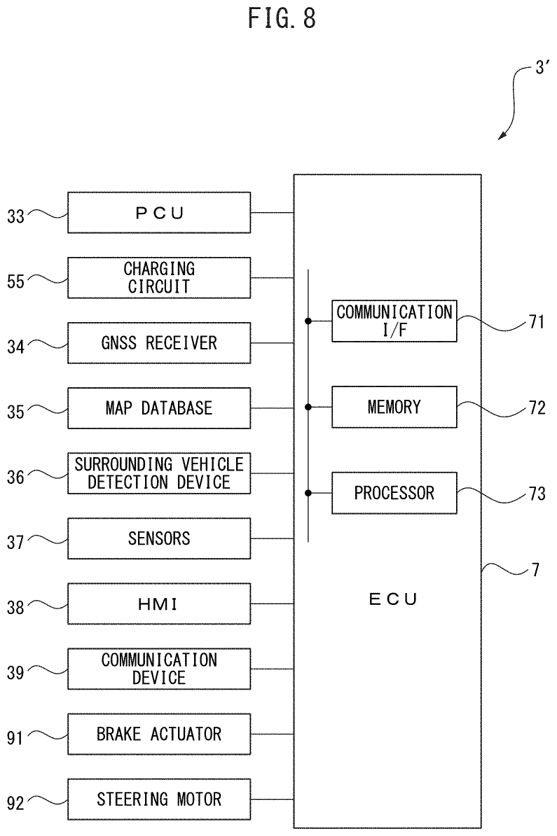

FIG. 8 is a functional block diagram of an ECU 7 in a vehicle 3′ according to the second embodiment and equipment connected to the ECU 7. In the second embodiment, the vehicle 3′ is further provided with a brake actuator 91 and a steering motor 92. The brake actuator 91 actuates brakes provided in the vehicle 3′. The steering motor 92 rotates a steering wheel provided in the vehicle 3′. The brake actuator 91 and the steering motor 92 are electrically connected to the ECU 7, and the ECU 7 controls these.

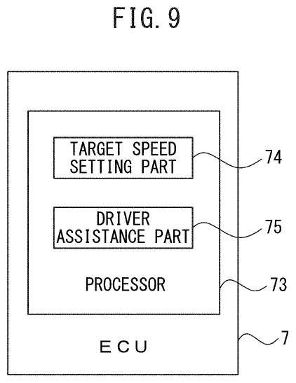

FIG. 9 is a functional block diagram of a processor 73 of the ECU 7 in the second embodiment. In the second embodiment, the processor 73 has a driver assistance part 75 in addition to the target speed setting part 74. The target speed setting part 74 and the driver assistance part 75 are functional modules realized by a computer program stored in the memory 72 of the ECU 7 being run by the processor 73 of the ECU 7. Note that, the target speed setting part 74 and the driver assistance part 75 may be realized by dedicated processing circuits provided at the processor 73.

The driver assistance part 75 controls running of the vehicle 3′. Specifically, the driver assistance part 75 controls acceleration, steering, and deceleration (braking) of the vehicle 3′. For example, the driver assistance part 75 controls the motor 31 via the PCU 33 to control acceleration of the vehicle 3′. Further, the driver assistance part 75 uses the brake actuator 91 to control deceleration (braking) of the vehicle 3′ and uses the steering motor 92 to control steering of the vehicle 3′. That is, the vehicle 3′ is a so-called automated driving vehicle. Note that, the driver assistance part 75 may control only the speed of the vehicle 3′ using the motor 31 and brake actuator 91 without controlling the steering of the vehicle 3′.

Like in the first embodiment, the target speed setting part 74 lowers the target speed of the vehicle 3′ in the power supply area when the predetermined conditions are satisfied, compared to when the predetermined conditions are not satisfied. Further, in the second embodiment, the driver assistance part 75 decelerates the vehicle 3′ so that the speed of the vehicle 3′ in the power supply area approaches the target speed set by the target speed setting part 74 when the predetermined conditions are satisfied. In this case, since the speed of the vehicle 3′ is automatically controlled, it is possible to better ensure that the speed of the vehicle 3′ when passing through the power supply area approaches the target speed.

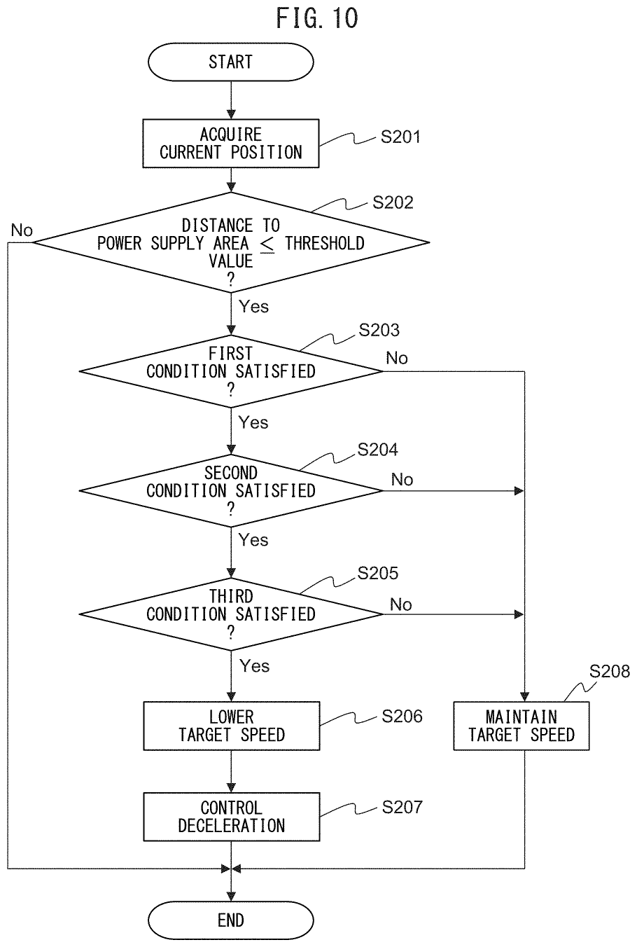

FIG. 10 is a flow chart showing a control routine carried out in the vehicle 3′ in the second embodiment. The present control routine is repeatedly performed by the processor 73 of the ECU 7.

Steps S201 to S206 and S208 are performed in the same manner as steps S101 to S106 and step S108 in FIG. 6. After step S206, the driver assistance part 75 at step S207 controls deceleration of the vehicle 3 based on the target speed set by the target speed setting part 74. Specifically, the driver assistance part 75 uses the brake actuator 91 to decelerate the vehicle 3 so that the speed of the vehicle 3 in the power supply area approaches the target speed. After step S207, the present control routine ends.

### Third Embodiment

The configuration and control of the power supply apparatus according to a third embodiment are basically similar to the configuration and control of the power supply apparatus according to the first embodiment except for the points explained below. For this reason, below, the third embodiment of the present disclosure will be explained focusing on parts different from the first embodiment.

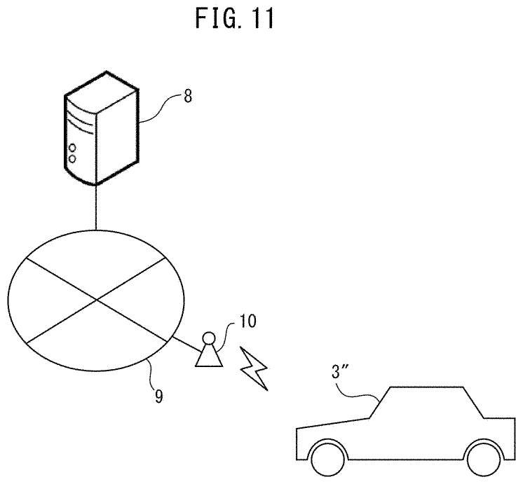

FIG. 11 is a view schematically showing a vehicle 3″ according to the third embodiment. In the third embodiment, the vehicle 3″ uses the communication device 39 to access a communication network 9 and communicate with a server 8 outside of the vehicle 3″ through a wireless base station 10 and the communication network 9.

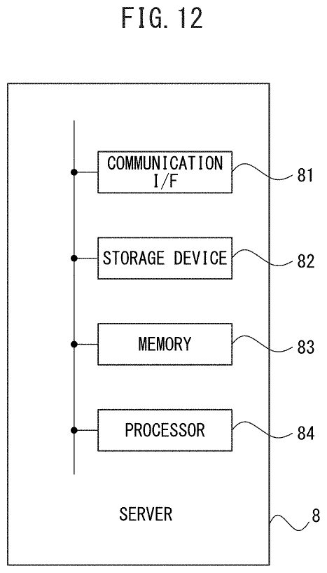

FIG. 12 is a view schematically showing the configuration of the server 8. The server 8 is provided with a communication interface 81, a storage device 82, a memory 83, and a processor 84. The communication interface 81, the storage device 82, and the memory 83 are connected to the processor 84 via signal wires. Note that, the server 8 may be further provided with an input device such as a keyboard and a mouse, an output device such as a display, etc. Further, the server 8 may be constituted by multiple computers.

The communication interface 81 has an interface circuit for connecting the server 8 to the communication network 9. The server 8 communicates with the vehicle 3″ through the communication network 9 and the wireless base station 10.

The storage device 82 has, for example, a hard disk drive (HDD), a solid state drive (SSD), or an optical recording medium and a access device of the same. The storage device 82 stores various data, for example, stores vehicle information, map information including position information of the power supply area, etc.

The memory 83 has a non-volatile semiconductor memory (for example, RAM). The memory 83 temporarily stores various data used, for example, when various processes are being run by the processor 84.

The processor 84 has one or more CPUs and peripheral circuits and performs various processes. Note that, the processor 84 may further have other processing circuits such as a logic unit, an arithmetic unit, or a graphic processing unit.

In the third embodiment, it is judged in the server 8 whether deceleration of the vehicle 3″ in the power supply area is allowable, and the target speed setting part 74 of the vehicle 3″ sets the target speed of the vehicle 3″ in the power supply area based on an instruction from the server 8. This makes it possible to judge satisfaction of predetermined conditions for allowing deceleration of the vehicle 3″ at the server 8 and reduce the processing load on the vehicle 3″.

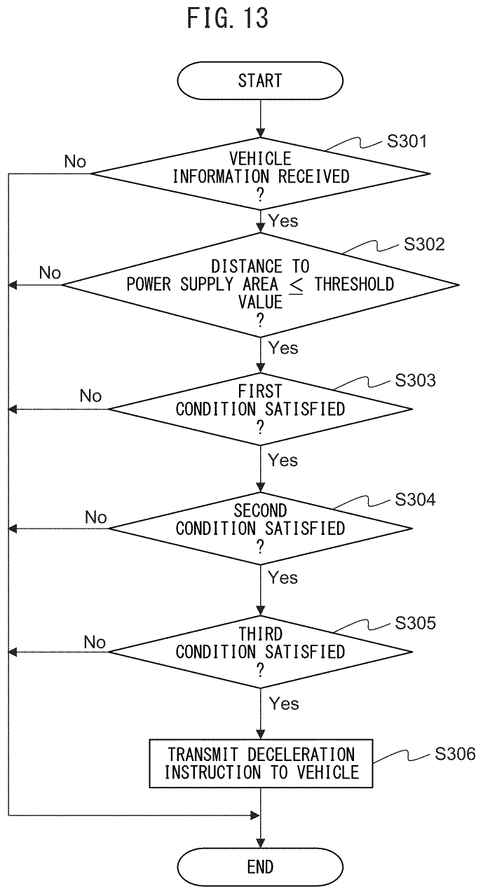

FIG. 13 is a flow chart showing a control routine carried out in the server 8 in the third embodiment. The present control routine is repeatedly performed by the processor 84 of the server 8.

First, at step S301, the processor 84 judges whether vehicle information has been received from the vehicle 3″. The vehicle 3″ periodically transmits vehicle information to the server 8, and the vehicle information includes identification information for the vehicle 3″ (for example, an identification number), the current position of the vehicle 3″, the speed of the vehicle 3″, the state of the battery 32 of the vehicle 3″, the operating schedule of the vehicle 3″ or the schedule of the occupant of the vehicle 3″, etc. Further, vehicle information is also periodically transmitted to the server 8 from surrounding vehicles capable of communicating with the server 8. If at step S301 it is judged that vehicle information has not been received from the vehicle 3″, the present control routine ends. On the other hand, if at step S301 it is judged that vehicle information has been received from the vehicle 3″, the present control routine proceeds to step S302.

At step S302, the processor 84 judges whether the distance from the current position of the vehicle 3″ to the power supply area is equal to or less than a predetermined threshold value based on the vehicle information transmitted from the vehicle 3″ and map information stored in the storage device 82 of the server 8. If the distance to the power supply area is longer than the threshold value, the present control routine ends. On the other hand, if the distance to the power supply area is equal to or less than the threshold value, the present control routine proceeds to step S303.

At step S303, the processor 84 judges whether a first condition relating to the running environment at the surroundings of the vehicle 3″ is satisfied. The first condition is similar to that in the first embodiment. Information used for judging satisfaction of the first condition is acquired based on the vehicle information transmitted from the vehicle 3″ and surrounding vehicles, the map information stored in the storage device 82 of the server 8, etc. If at step S303 it is judged that the first condition is not satisfied, the present control routine ends. On the other hand, if at step S303 it is judged that the first condition is satisfied, the present control routine proceeds to step S304.

At step S304 the processor 84 judges whether a second condition relating to the state of the battery 32 is satisfied. The second condition is similar to that in the first embodiment. Information used for judging satisfaction of the second condition is acquired based on vehicle information transmitted from the vehicle 3″. If at step S304 it is judged that the second condition is not satisfied, the present control routine ends. On the other hand, if at step S304 it is judged that the second condition is satisfied, the present control routine proceeds to step S305.

At step S305 the processor 84 judges whether a third condition relating to the operating schedule of the vehicle 3″ or the schedule of the occupant of the vehicle 3″ is satisfied. The third condition is similar to that in the first embodiment. Information used for judging satisfaction of the third condition is acquired based on the vehicle information transmitted from the vehicle 3″. If at step S305 it is judged that the third condition is not satisfied, the present control routine ends. On the other hand, if at step S305 it is judged that the third condition is satisfied, the present control routine proceeds to step S306.

At step S306, the processor 84 transmits a deceleration instruction through the communication network 9 to the vehicle 3″. After step S306, the present control routine ends.

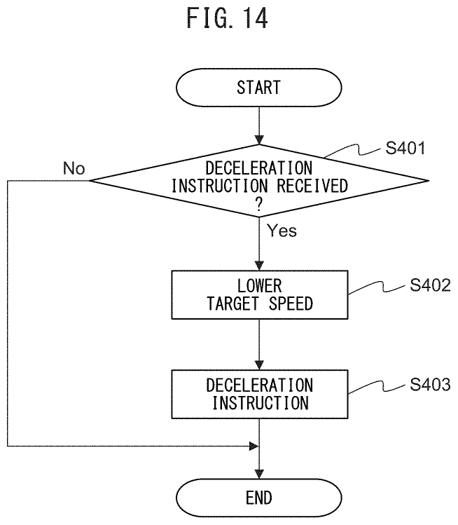

FIG. 14 is a flow chart showing a control routine performed at the vehicle 3″ in the third embodiment. The present control routine is repeatedly performed by the processor 73 of the ECU 7.

First, at step S401 the target speed setting part 74 judges whether it has received a deceleration instruction from the server 8. If it is judged that a deceleration instruction has not been received from the server 8, the present control routine ends. On the other hand, if is judged that a deceleration instruction has been received from the server 8, the present control routine proceeds to step S402.

At step S402, in the same way as step S106 of FIG. 6, the target speed setting part 74 lowers the target speed of the vehicle 3 in the power supply area. Next, at step S403, in the same way as step S107 of FIG. 6, the target speed setting part 74 makes the HMI 38 output a deceleration instruction so that the speed of the vehicle 3 in the power supply area approaches the target speed. After step S403, the present control routine ends.

### Other Embodiments

Above, preferred embodiments according to the present disclosure were explained, but the present disclosure is not limited to these embodiments and can be corrected and changed within the language of the claims. For example, the vehicle 3, 3′, 3″ may be a hybrid vehicle (HEV) or a plug-in hybrid vehicle (PHEV) provided with an internal combustion engine and a motor as power sources for driving.

Further, the above-mentioned embodiments may be worked combined in any way. For example, if the second embodiment and the third embodiment are combined, at step S403 of FIG. 14, in the same way as step S207 of FIG. 10, the driver assistance part 75 uses the brake actuator 91 to decelerate the vehicle 3″ so that the speed of the vehicle 3″ at the power supply area approaches the target speed.

### REFERENCE SIGNS LIST

2. power supply apparatus
3. vehicle
44. power transmission coil
7. electronic control unit (ECU)
73. processor
74. target speed setting part

1. A vehicle control device for controlling a vehicle configured to receive power by non-contact from a power transmission coil when passing over the power transmission coil, comprising:
a processor configured to set a target speed of the vehicle in a power supply area where the power transmission coil is installed, wherein
the processor is configured to lower the target speed when at least one predetermined condition is satisfied, compared to when the at least one predetermined condition is not satisfied, and
the at least one predetermined condition includes a first condition relating to a running environment around the vehicle.

2. The vehicle control device according to claim 1, wherein the first condition includes a positional condition relating to a positional relationship between a rear vehicle running behind the vehicle and the vehicle.

3. The vehicle control device according to claim 2, wherein the positional condition is satisfied when a distance between the vehicle and the rear vehicle is equal to or greater than a predetermined distance.

4. The vehicle control device according to claim 2, wherein the positional condition is satisfied when a time to collision of the rear vehicle with respect to the vehicle when the target speed of the vehicle is lowered is equal to or greater than a predetermined time.

5. The vehicle control device according to claim 2, wherein the positional condition is satisfied when a time for the rear vehicle to reach a current position of the vehicle is equal to or greater than a predetermined time.

6. The vehicle control device according to claim 2, wherein the rear vehicle is a following vehicle located behind the vehicle on the same lane as the vehicle.

7. The vehicle control device according to claim 1, wherein the first condition includes a lane-changing condition relating to an ease of changing lanes from a lane of the power supply area to another lane.

8. The vehicle control device according to claim 7, wherein the lane-changing condition is satisfied when the number of lanes in the same direction of advance on a road where the power supply area has been established is equal to or greater than a predetermined number of two or more.

9. The vehicle control device according to claim 7, wherein the lane-changing condition is satisfied when the number of surrounding vehicles located in a predetermined range on a lane adjacent to the lane of the power supply area is equal to or less than a predetermined number.

10. The vehicle control device according to claim 1, wherein the first condition includes a congestion condition relating to congestion in an area in front of the power supply area.

11. The vehicle control device according to claim 10, wherein the congestion condition is satisfied when there is no possibility of congestion in the area in front of the power supply area.

12. The vehicle control device according to claim 1, wherein the vehicle comprises a battery, and the at least one predetermined condition includes a second condition relating to a state of the battery.

13. The vehicle control device according to claim 1, wherein the at least one predetermined condition includes a third condition relating to operating schedule of the vehicle or a schedule of an occupant of the vehicle.

14. The vehicle control device according to claim 13, wherein the third condition is satisfied when the occupant has no schedule within a predetermined time from an estimated time of arrival of the vehicle at a destination.

15. The vehicle control device according to claim 1, wherein the vehicle comprises an output device, and the processor is configured to make the output device output a deceleration instruction so that a speed of the vehicle in the power supply area approaches the target speed, if the at least one predetermined condition is satisfied.

16. The vehicle control device according to claim 1, wherein the processor is configured to control running of the vehicle, and decelerate the vehicle so that the speed of the vehicle in the power supply area approaches the target speed, if the at least one predetermined condition is satisfied.

17. A vehicle control method for controlling a vehicle configured to receive power by non-contact from a power transmission coil when passing over the power transmission coil, including:
lowering a target speed of the vehicle in a power supply area where the power transmission coil is installed, when at least one predetermined condition is satisfied, compared to when the at least one predetermined condition is not satisfied, wherein
the at least one predetermined condition includes a first condition relating to a running environment around the vehicle.
